(19) United States
(12) Patent Application Publication
(10) Pub. No.: US 2023/0095745 A1
(43) Pub. Date: Mar. 30, 2023

(54) COMPUTER-READABLE RECORDING MEDIUM STORING POSTED CONTENT AUDIT PROGRAM AND POSTED CONTENT AUDIT METHOD

(71) Applicant: FUJITSU LIMITED, Kawasaki-shi (JP)

(72) Inventor: Koki INOUE, Kawasaki (JP)

(73) Assignee: FUJITSU LIMITED, Kawasaki-shi (JP)

(21) Appl. No.: 17/752,965

(22) Filed: May 25, 2022

(30) Foreign Application Priority Data
Sep. 9, 2021 (JP) 2021-146611

(51) Int. Cl. G06Q 50/00

(52) U.S. Cl. CPC G06Q 50/01

(57) ABSTRACT

A non-transitory computer-readable recording medium stores a posted content audit program for causing a computer to execute processing including: imposing a first deposit when a first user posts posted content on a social platform; imposing a second deposit when a second user posts counterargument content against the posted content; receiving voting regarding whether or not the counterargument content is valid and evaluating whether or not the counterargument content is valid; returning the second deposit and returning an incentive to the second user in a case where it is evaluated that the counterargument content is valid as a result of the voting; and determining a condition when it is evaluated whether or not the counterargument content is valid or return content of the incentive so that the second user does not gain a profit even when the second user offers bribes to a user who casts the vote and commits fraud.

### CROSS-REFERENCE TO RELATED APPLICATION

This application is based upon and claims the benefit of priority of the prior Japanese Patent Application No. 2021-146611, filed on Sep. 9, 2021, the entire contents of which are incorporated herein by reference.

### FIELD

The embodiments discussed herein are related to a posted content audit program and a posted content audit method.

### BACKGROUND

In recent years, it becomes a social problem that misinformation is posted or disinformation (intentional false information, so-called fake news) is posted on a social platform, and this causes spread of incorrect information.

Japanese Laid-open Patent Publication No. 2014-174912 is disclosed as related art.

### SUMMARY

According to an aspect of the embodiments, a non-transitory computer-readable recording medium stores a posted content audit program for causing a computer to execute processing including: imposing a first deposit when a first user posts posted content on a social platform; imposing a second deposit when a second user posts counterargument content against the posted content; receiving voting regarding whether or not the counterargument content is valid and evaluating whether or not the counterargument content is valid; returning the second deposit and returning an incentive to the second user in a case where it is evaluated that the counterargument content is valid as a result of the voting; and determining a condition when it is evaluated whether or not the counterargument content is valid or return content of the incentive so that the second user does not gain a profit even when the second user offers bribes to a user who casts the vote and commits fraud.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing system according to a first embodiment;

FIG. 2A is a diagram illustrating a hardware configuration of a terminal device, and FIG. 2B is a diagram illustrating a hardware configuration of a server;

FIG. 3 is a functional block diagram of the server;

FIGS. 4A and 4B are diagrams for explaining an outline of processing in a social platform;

FIG. 5A is a flowchart illustrating processing of a posting reception unit, and FIG. 5B is a diagram illustrating an example of a posting screen;

FIG. 6 is a flowchart illustrating processing of an audit reception unit;

FIG. 7A is a diagram illustrating an example of a counterargument reception screen, and FIG. 7B is a diagram illustrating a counterargument posting screen;

FIG. 8 is a flowchart illustrating processing of a voting reception unit;

FIG. 9 is a diagram illustrating an example of a voting screen;

FIG. 10 is a flowchart illustrating processing of an adoption determination unit;

FIG. 11 is a diagram illustrating an example of an adopted screen;

FIG. 12 is a flowchart illustrating processing of a deposit management unit;

FIGS. 13A and 13B are diagrams for explaining collusion fraud measures according to the first embodiment;

FIG. 14 is a flowchart illustrating processing of an adoption determination unit according to a second embodiment;

FIG. 15 is a diagram for explaining collusion fraud measures according to the second embodiment;

FIG. 16A is a diagram illustrating an example of a voting screen according to a third embodiment, and FIG. 16B is a diagram illustrating an example of an adopted screen according to the third embodiment; and

FIG. 17 is a flowchart illustrating processing of an adoption determination unit according to the third embodiment.

### DESCRIPTION OF EMBODIMENTS

Typically, a technique has been known in which content such as an image or a song produced and posted by a user is evaluated by another user.

Japanese Laid-open Patent Publication No. 2014-174912 discloses an example in which a user who posts a comment to content is rewarded. In this example, votes for and against the comment are received, and the user is rewarded according to an approval rating (the number of approving votes/the number of votes).

However, with the technique described in Japanese Laid-open Patent Publication No. 2014-174912 above, for example, if a user who made an unjust comment on valid posted content offers a bribe to and colludes with another user, it is possible to spread the unjust comment as correct information. Furthermore, as a result, the user who has posted the unjust comment can obtain a reward. Therefore, according to the technique described above, there is a possibility that the spread of incorrect information is further promoted.

In one aspect, an object of the embodiment is to provide a posted content audit program and a posted content audit method that can prevent spread of misinformation or disinformation in a social platform.

### FIRST EMBODIMENT

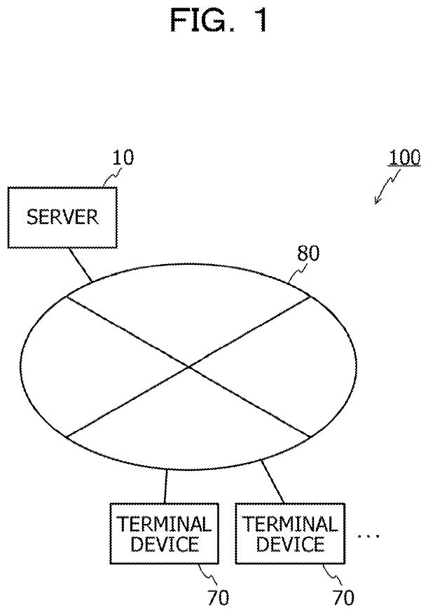

Hereinafter, a first embodiment of an information processing system will be described in detail with reference to FIGS. 1 to 13B.

In FIG. 1, a configuration of an information processing system 100 according to the first embodiment is schematically illustrated. As illustrated in FIG. 1, the information processing system 100 includes a server 10 and a plurality of terminal devices 70. The server 10 and the terminal device 70 are connected to each other via a network 80 such as the Internet. The terminal device 70 is a device used by a user to post or browse character string information or image information in a social platform provided by the information processing system 100. Furthermore, the terminal device 70 is used by a user to argue against posted content or to vote whether or not the counterargument is valid.

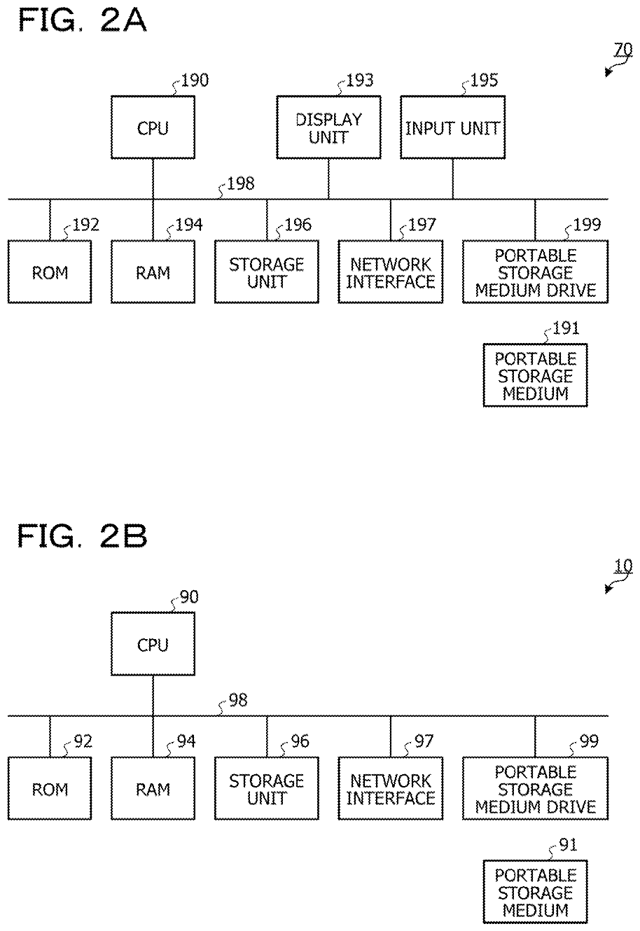

FIG. 2A illustrates a hardware configuration of the terminal device 70. As illustrated in FIG. 2A, the terminal device 70 includes a central processing unit (CPU) 190, a read only memory (ROM) 192, a random access memory (RAM) 194, a storage unit (here, solid state drive (SSD)) 196,

a network interface 197, a display unit 193, an input unit 195, a portable storage medium drive 199, or the like. Each of these components of the terminal device 70 is connected to a bus 198. The display unit 193 includes a liquid crystal display or the like, and the input unit 195 includes a keyboard, a mouse, a touch panel, or the like. The portable storage medium drive 199 is a device that reads information from or writes information into a portable storage medium 191.

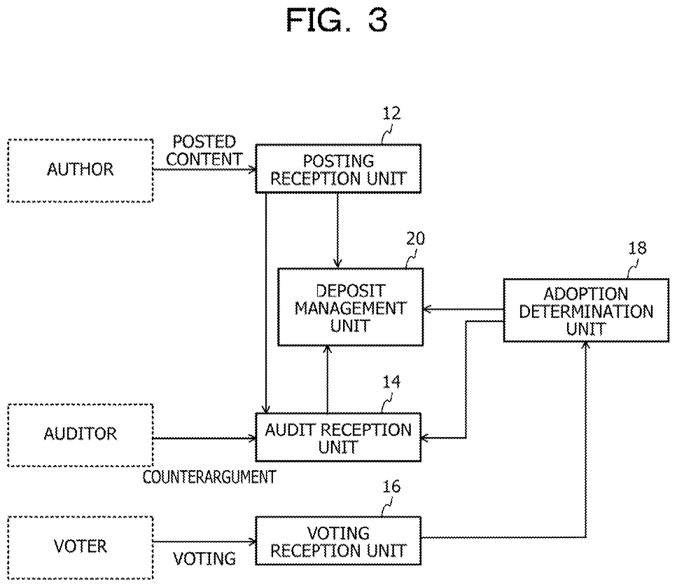

The server 10 has a hardware configuration as illustrated in FIG. 2B. For example, the server 10 includes a CPU 90, a ROM 92, a RAM 94, a storage unit (for example, SSD) 96, a network interface 97, a portable storage medium drive 99, or the like. Each of these components of the server 10 is connected to a bus 98. In the server 10, the CPU 90 executes a program (including posted content audit program) stored in the ROM 92 or the storage unit 96 or a program (including posted content audit program) read from a portable storage medium 91 by the portable storage medium drive 99, so as to implement a function of each unit illustrated in FIG. 3. Note that the function of each unit in FIG. 3 may be implemented by, for example, an integrated circuit such as an application specific integrated circuit (ASIC) or a field programmable gate array (FPGA).

In the server 10, the CPU 90 executes programs so as to function as a posting reception unit 12, an audit reception unit 14, a voting reception unit 16, an adoption determination unit 18, and a deposit management unit 20 illustrated in FIG. 3.

The posting reception unit 12 executes processing for receiving information (posted content) posted by a first user (hereinafter, referred to as “author”) from the terminal device 70 and for displaying the information.

The audit reception unit 14 executes processing for receiving a counterargument by a second user (hereinafter, referred to as an “auditor”) against the posted content that has been already posted by the author and displaying the received counterargument in association with the posted content.

The voting reception unit 16 receives a result of voting by a user other than the first and second users from the terminal device 70. This user who casts this vote is referred to as a “voter” below. The voter casts a vote whether or not the counterargument posted by the auditor is valid. The voting reception unit 16 executes processing for displaying the received voting result in association with the counterargument.

The adoption determination unit 18 determines whether or not it is possible to evaluate that the counterargument of the auditor is valid on the basis of the voting result by the voter against the counterargument of the auditor. Then, in a case where it is possible to evaluate that the counterargument is valid, the adoption determination unit 18 notifies the deposit management unit 20 of that.

The deposit management unit 20 executes processing for receiving deposits (money, points, coin tickets, or the like) when the author posts or when the auditor makes a counterargument. Note that, in the first embodiment, it is assumed that the deposit management unit 20 manage money (yen) used by each user in the social platform in an account of each user. Then, the deposit management unit 20 executes processing for deducting the deposit from the account of the user and transferring the deposit to a management account when the user makes a post or counterargument.

Furthermore, the deposit management unit 20 determines to which user (author or auditor) the deposit is returned and an incentive is returned. Then, the deposit management unit 20 executes processing for returning the deposit from the management account to the determined account of the user and transferring incentive money to the determined account of the user.

### About Outline of Processing

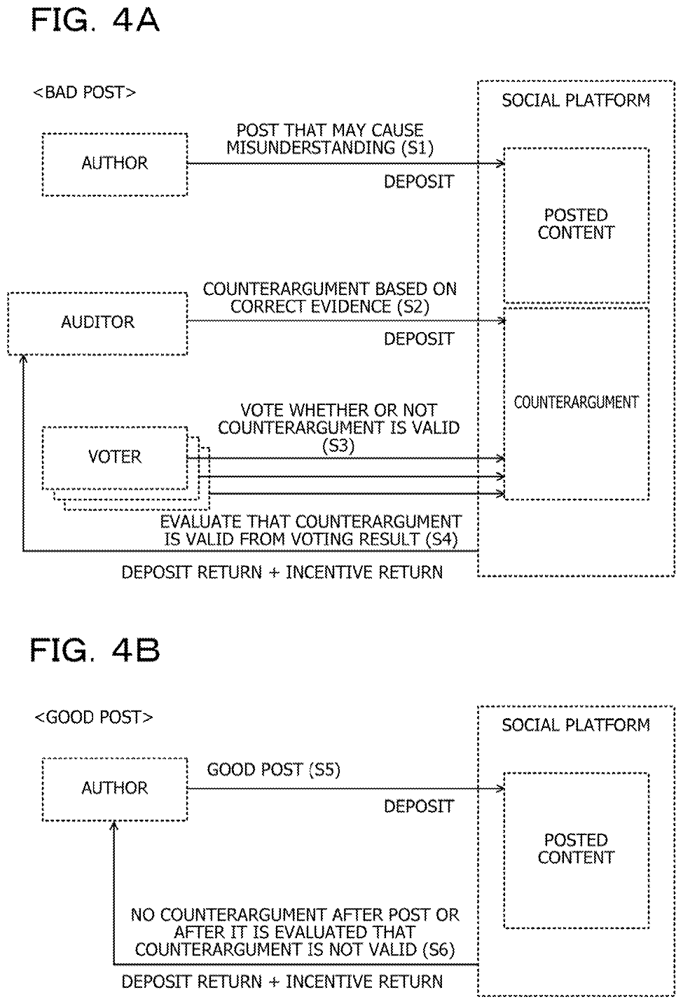

FIGS. 4A and 4B illustrate an outline of processing in the social platform. FIG. 4A illustrates an example of a case where an author makes a bad post, and FIG. 4B illustrates an example of a case where the author makes a good post.

### A Case Where Bad Post is Made

As illustrated in FIG. 4A, the author pays a deposit to post on the social platform. The server 10 collects counterarguments against the posted content for a predetermined period of time. In a case where this post has bad posted content that may cause misunderstanding (S1), an auditor who has a counterargument pays a deposit and posts a counterargument based on a correct evidence (S2). When the counterargument is posted, the server 10 collects votes regarding the counterargument content (vote whether or not counterargument is valid). When the voter casts a vote for this collection (S3), the server 10 evaluates whether or not the counterargument is valid on the basis of the voting result, and returns the deposit and applies (return) an incentive to the auditor when the counterargument is evaluated as valid as a result of the evaluation (S4). On the other hand, in a case of evaluating that the counterargument is not valid, the server 10 re-collects counterarguments for a predetermined period of time.

### A Case Where Good Post is Made

As illustrated in FIG. 4B, the author pays a deposit to post on the social platform. In a case where this post has good posted content (S5), even if the server 10 collects counterarguments for a predetermined period of time, counterarguments are not posted in many cases. If the counterargument is not posted in this way, the server 10 applies an incentive to the author after the predetermined period of time has elapsed (S6). Furthermore, in a case of the good posted content, even if the auditor makes a counterargument, it is evaluated that the counterargument is not valid from the voting result. In this case, the server 10 re-collects counterarguments for a predetermined period of time, and if counterarguments are not posted, the server 10 returns the deposit and applies (return) an incentive to the author (S6).

### About Processing of Each Unit of Server 10

Hereinafter, processing content executed by each unit of the server 10 will be described in detail.

### Processing of Posting Reception Unit 12

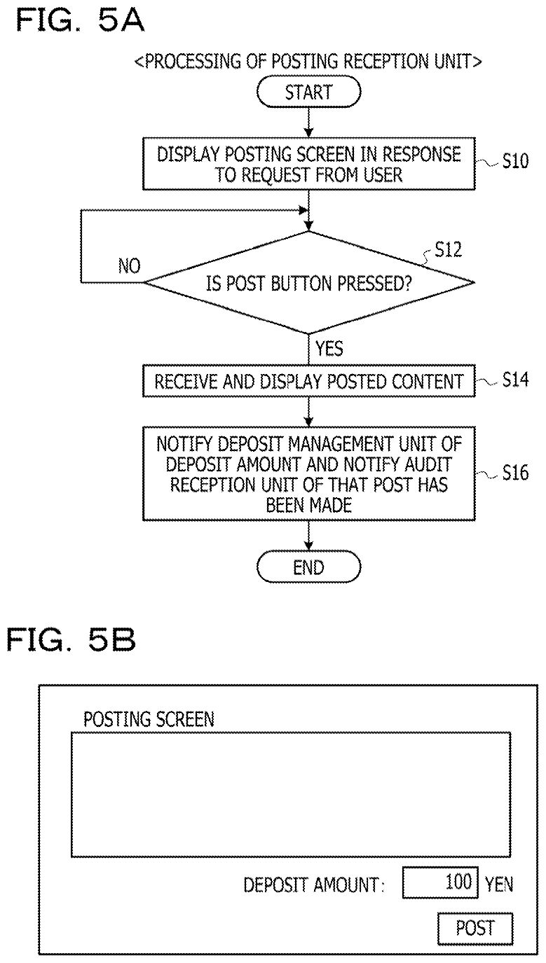

FIG. 5A is a flowchart illustrating processing of the posting reception unit 12. In step S10, the posting reception unit 12 displays a posting screen in response to a request from a user (author). FIG. 5B illustrates an example of the posting screen. In the posting screen, an input field for a deposit amount and a “post” button are provided, in addition to an input field to which posted content is input. The author inputs posted content to the input field and inputs a deposit amount, and then, presses the “post” button so as to post the input posted content on the social platform.

After step S10, the posting reception unit 12 waits until the “post” button in the posting screen is pressed in step S12. When the author presses the “post” button, the procedure proceeds to step S14, and the posting reception unit 12 receives and displays the posted content (open to other users).

Next, in step S16, the posting reception unit 12 notifies the deposit management unit 20 of the deposit amount and notifies the audit reception unit 14 of that the post has been made. Thus, the entire processing in FIG. 5A ends. Note that the processing in FIG. 5A is repeatedly executed.

### Processing of Audit Reception Unit 14

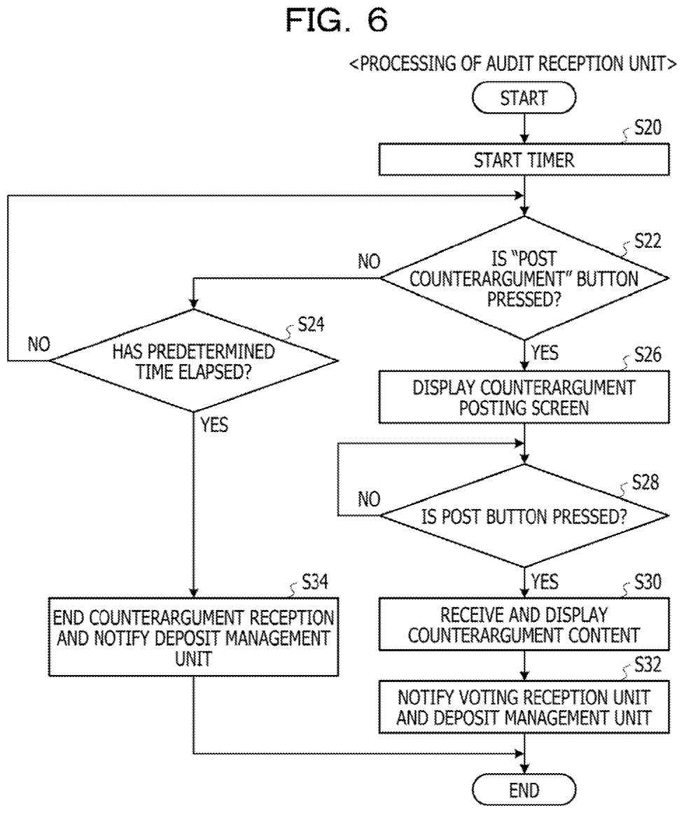

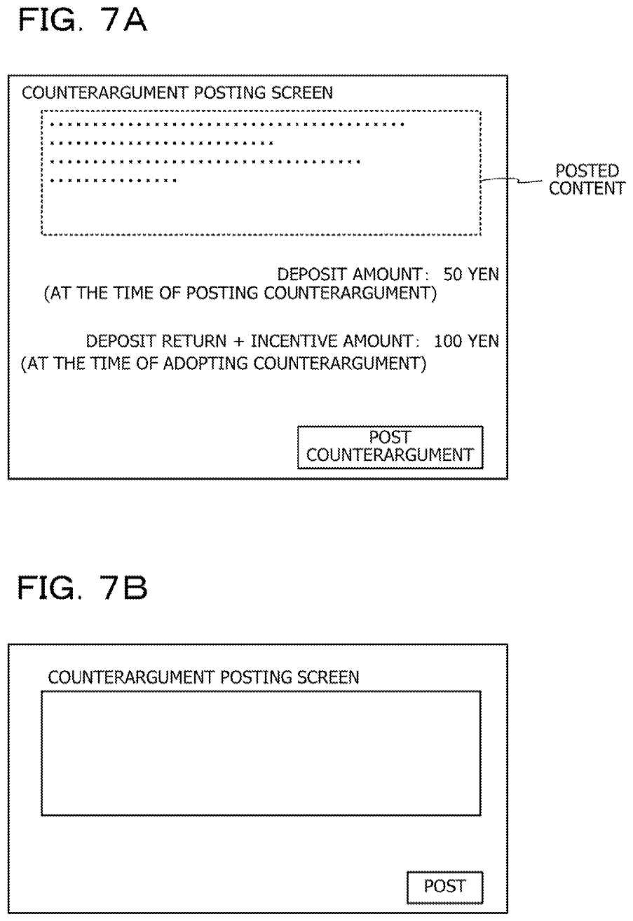

Next, processing of the audit reception unit 14 will be described with reference to FIG. 6. The processing in FIG. 6 starts at a timing when a notification is issued from the posting reception unit 12, for example, a timing when the processing in step S16 in FIG. 5A is executed. Note that, when the processing in FIG. 6 starts, the terminal device 70 of the user (auditor) can display a counterargument reception screen as illustrated in FIG. 7A. In the counterargument reception screen in FIG. 7A, posted content by the author, a deposit amount (amount is fixed) in a case where a counterargument is posted, and an amount (amount is fixed) in a case where a deposit is returned and an incentive is returned are displayed. Furthermore, in the screen in FIG. 7A, a “post counterargument” button is provided.

When the processing in FIG. 6 starts, in step S20, the audit reception unit 14 starts a timer. This timer measures a deadline for a counterargument against the post from the author (counterargument reception period).

Next, when the procedure proceeds to step S22, the audit reception unit 14 determines whether or not the “post counterargument” button is pressed by the user (auditor). If the determination in step S22 is negative, the procedure proceeds to step S24, and the audit reception unit 14 determines whether or not a predetermined time (counterargument reception period) has elapsed. In a case where the determination in step S24 is negative, the procedure returns to step S22.

On the other hand, when the determination is step S22 is positive and the procedure proceeds to step S26, the audit reception unit 14 display a counterargument posting screen. The counterargument posting screen is a screen as illustrated in FIG. 7B. In the counterargument posting screen, a field in which counterargument content is input and a “post” button are provided.

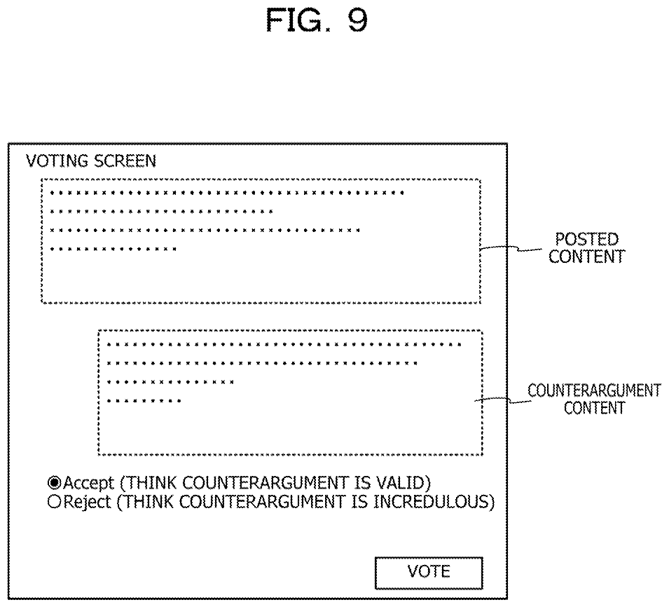

Next, in step S28, the audit reception unit 14 waits until the post button is pressed. When the “post” button is pressed by the user (auditor), the procedure proceeds to step S30, and the audit reception unit 14 receives the counterargument content and makes it possible to display a voting screen as illustrated in FIG. 9 on the terminal device 70 of each user. In the voting screen in FIG. 9, the posted content and the counterargument content are displayed in association with each other. Furthermore, in the voting screen, a field in which “Accept (think it is valid counterargument)” or “Reject (think counterargument is incredulous)” regarding the counterargument content is selected and a “voting” button pressed when the selected opinion is voted are provided.

Next, in step S32, because the counterargument content is received, the audit reception unit 14 notifies the voting reception unit 16 of that voting reception should be started. Furthermore, the audit reception unit 14 notifies the deposit management unit 20 of that the counterargument has been posted. Thereafter, the entire processing in FIG. 6 ends.

On the other hand, when the determination in step S24 is positive before step S22 is positive (before “post counterargument” button is pressed in screen in FIG. 7A), the audit reception unit 14 proceeds the procedure to step S34. When the procedure proceeds to step S34, the audit reception unit 14 ends the reception of the counterarguments and notifies the deposit management unit 20 of the end of the reception. A case where the procedure proceeds to step S34 means that there is no counterargument against the posted content. After the processing in step S34, the entire processing in FIG. 6 ends.

### Processing of Voting Reception Unit 16

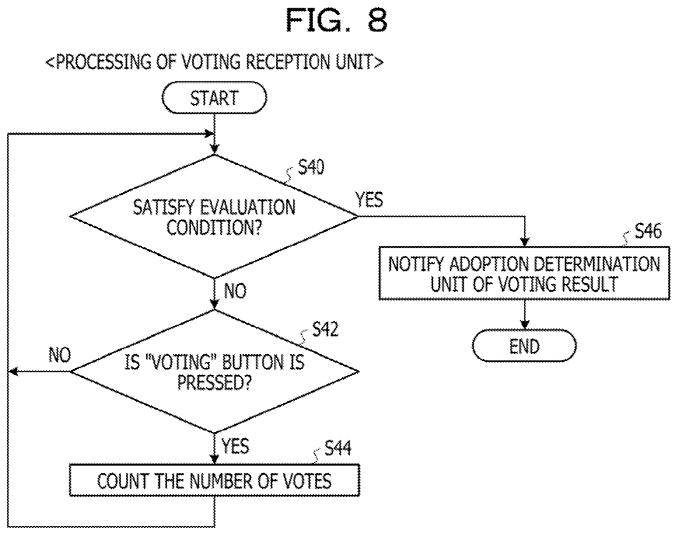

Next, processing of the voting reception unit 16 will be described with reference to FIG. 8. The processing in FIG. 8 starts at a timing when a notification is issued from the audit reception unit 14, for example, a timing when the processing in step S32 in FIG. 6 is executed. Note that, when the processing in FIG. 8 starts, the terminal device 70 of the user (voter) can display the voting screen in FIG. 9.

When the processing in FIG. 8 starts, in step S40, the voting reception unit 16 determines whether or not an evaluation condition is satisfied. The evaluation condition is, for example, a case where the total number of votes against the counterargument is equal to or more than a predetermined number, a case where a predetermined period (voting reception period) has elapsed from the start of the processing in FIG. 8, or the like. In the first embodiment, as an example, it is assumed that the determination in step S40 be positive in a case where the total number of votes is equal to or more than a predetermined number (minimum number of votes, for example, 100 people).

In a case where the determination in step S40 is negative, the procedure proceeds to step S42, and the voting reception unit 16 determines whether or not the “voting” button in the voting screen in FIG. 9 is pressed. In a case where the determination in step S42 is negative, the procedure returns to step S40. On the other hand, when the determination in step S42 is positive, the procedure proceeds to step S44, the voting reception unit 16 counts the number of votes. For example, in a case where the “voting” button is pressed in a state where “Accept” in the voting screen is selected, the voting reception unit 16 increments an “Accept” vote and the total number of votes by one. In a case where the “voting” button is pressed in a state where “Reject” in the voting screen is selected, the voting reception unit 16 increments a “Reject” vote and the total number of votes by one. After executing step S44, the voting reception unit 16 returns to step S40.

On the other hand, in a case where the determination in step S40 is positive, the voting reception unit 16 notifies the adoption determination unit 18 of the voting result. Here, it is assumed that the voting reception unit 16 notify the adoption determination unit 18 of each of the number of “Accept” votes and the number of “Reject” votes as the voting result. After the processing in step S46 is executed, the entire processing in FIG. 8 ends.

### Processing of Adoption Determination Unit 18

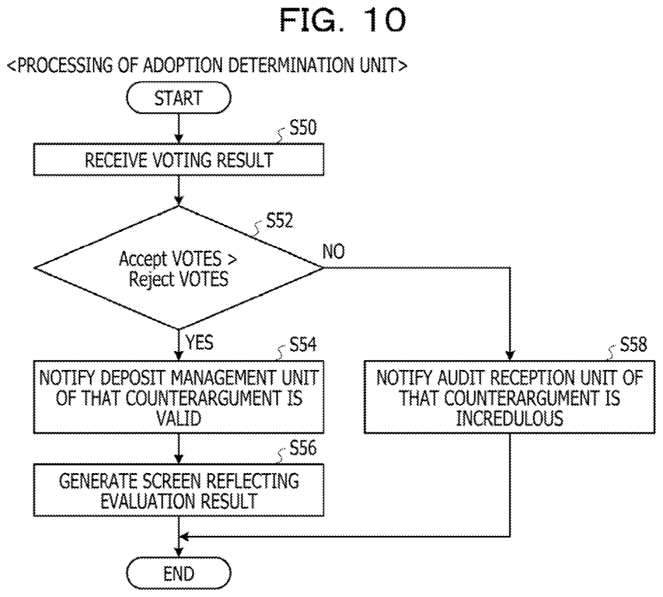

Next, processing of the adoption determination unit 18 will be described with reference to FIG. 10. The processing in FIG. 10 starts at a timing when the notification of the voting result is issued from the voting reception unit 16, for example, a timing when the processing in step S46 in FIG. 10 is executed.

When the processing in FIG. 10 starts, in step S50, the adoption determination unit 18 receives (acquire) the voting result notified from the voting reception unit 16.

Next, in step S52, the adoption determination unit 18 determines whether or not the number of Accept votes (vote indicating that counterargument is valid) is larger than the number of “Reject” votes (vote indicating that counterargument is incredulous). When the determination in step S52 is positive, the adoption determination unit 18 proceeds the procedure to step S54.

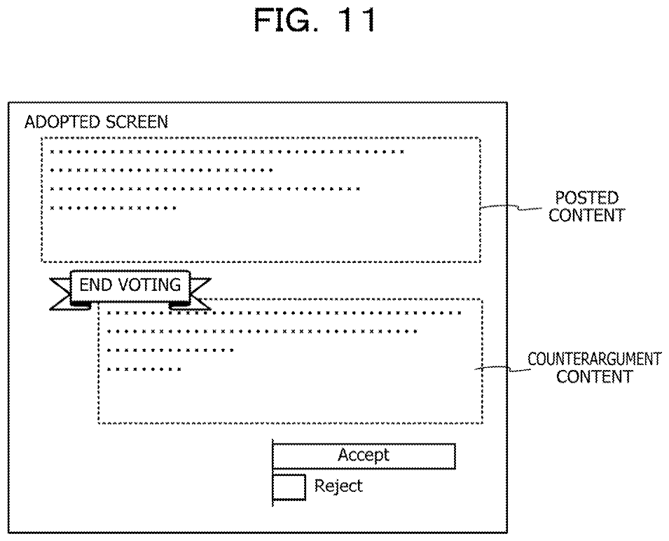

When the procedure proceeds to step S54, the adoption determination unit 18 notifies the deposit management unit 20 of that the counterargument is valid. Next, in step S56, the adoption determination unit 18 generates a screen reflecting the evaluation result (refer to adopted screen in FIG. 11) and makes it possible to display the screen on the terminal device 70. In the adopted screen in FIG. 11, the posted content and the counterargument content are displayed in association with each other. Furthermore, in the adopted screen, a display indicating that the voting ends and a display of the voting result (the number and ratio of each of Accept votes and Reject votes) are provided. After the processing in step S56 is executed, the entire processing in FIG. 10 ends.

On the other hand, in a case where the determination in step S52 is negative, the procedure proceeds to step S58, the adoption determination unit 18 notifies the audit reception unit 14 of that the counterargument is incredulous. Thereafter, the entire processing in FIG. 10 ends. Note that, in a case of receiving the notification from the adoption determination unit 18, the audit reception unit 14 executes the processing in FIG. 6. For example, the audit reception unit 14 waits for positing of a new counterargument until a predetermined time (counterargument reception period) has elapsed. Then, in a case where the counterargument reception period has elapsed, the audit reception unit 14 ends the reception of the counterarguments and notifies the deposit management unit 20 of the end of the reception (S34). Furthermore, in a case where a new counterargument is posted, the audit reception unit 14 notifies the voting reception unit 16 of that (S32). As a result, as described above, the processing by the voting reception unit 16 (FIG. 8) and the processing by the adoption determination unit 18 (FIG. 10) are executed again.

### Processing of Deposit Management Unit 20

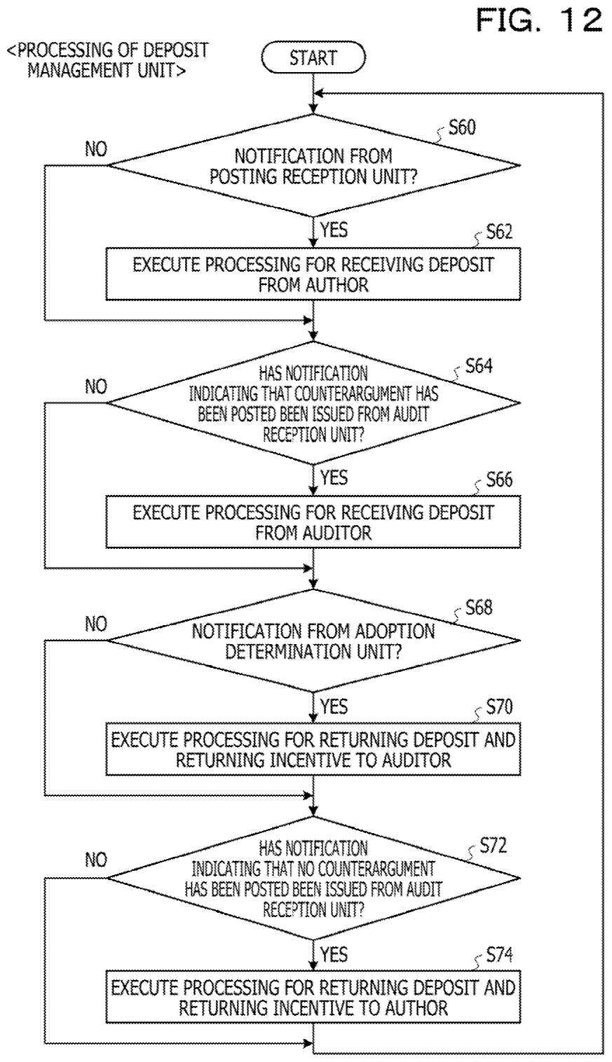

Next, processing of the deposit management unit 20 will be described with reference to FIG. 12.

The deposit management unit 20 determines in step S60 whether or not a notification has been issued from the posting reception unit 12. For example, it is determined whether or not the processing in step S16 in FIG. 5A has been executed. In a case where the determination in step S60 is positive, the procedure proceeds to step S62, and the deposit management unit 20 executes processing for receiving a deposit from the author. For example, the deposit management unit 20 executes processing for deducting the deposit amount input by the author into the posting screen in FIG. 5B from the account of the author and transferring the deposit amount to the management account. Thereafter, the procedure proceeds to step S64. On the other hand, in a case where the determination in step S60 is negative, the procedure proceeds to step S64 without through step S62.

When the procedure proceeds to step S64, the deposit management unit 20 determines whether or not a notification indicating that a counterargument has been posted has been issued from the audit reception unit 14. For example, it is determined whether or not the processing in step S32 in FIG. 6 has been executed. In a case where the determination in step S64 is positive, the procedure proceeds to step S66, and the deposit management unit 20 executes processing for receiving a deposit from the auditor. For example, the deposit management unit 20 executes processing for deducting the deposit amount displayed on the counterargument reception screen in FIG. 7A from the account of the auditor and transferring the deposit amount to the management account. Thereafter, the procedure proceeds to step S68. On the other hand, in a case where the determination in step S64 is negative, the procedure proceeds to step S68 without through step S66.

When the procedure proceeds to step S68, the deposit management unit 20 determines whether or not a notification has been issued from the adoption determination unit 18. For example, it is determined whether or not the processing in step S54 in FIG. 10 has been executed. In a case where the determination in step S68 is positive, the procedure proceeds to step S70, and the deposit management unit 20 executes processing for returning the deposit and returning the incentive to the auditor. For example, the deposit management unit 20 executes processing for deducting the amount (deposit+incentive) displayed on the counterargument reception screen in FIG. 7A from the management account and transferring the amount to the account of the auditor. Thereafter, the procedure proceeds to step S72. On the other hand, in a case where the determination in step S68 is negative, the procedure proceeds to step S72 without through step S70.

When the procedure proceeds to step S72, the deposit management unit 20 determines whether or not a notification indicating that no counterargument has been posted has been issued from the audit reception unit 14. For example, it is determined whether or not the processing in step S34 in FIG. 6 has been executed. In a case where the determination in step S72 is positive, the procedure proceeds to step S74, and the deposit management unit 20 executes processing for returning the deposit and returning the incentive to the author. For example, the deposit management unit 20 executes processing for deducting a predetermined amount (deposit+incentive) from the management account and transferring the predetermined amount to the account of the author. Thereafter, the procedure returns to step S60. On the other hand, in a case where the determination in step S72 is negative, the procedure returns to step S60 without through step S74.

### About Measures against Collusion Fraud

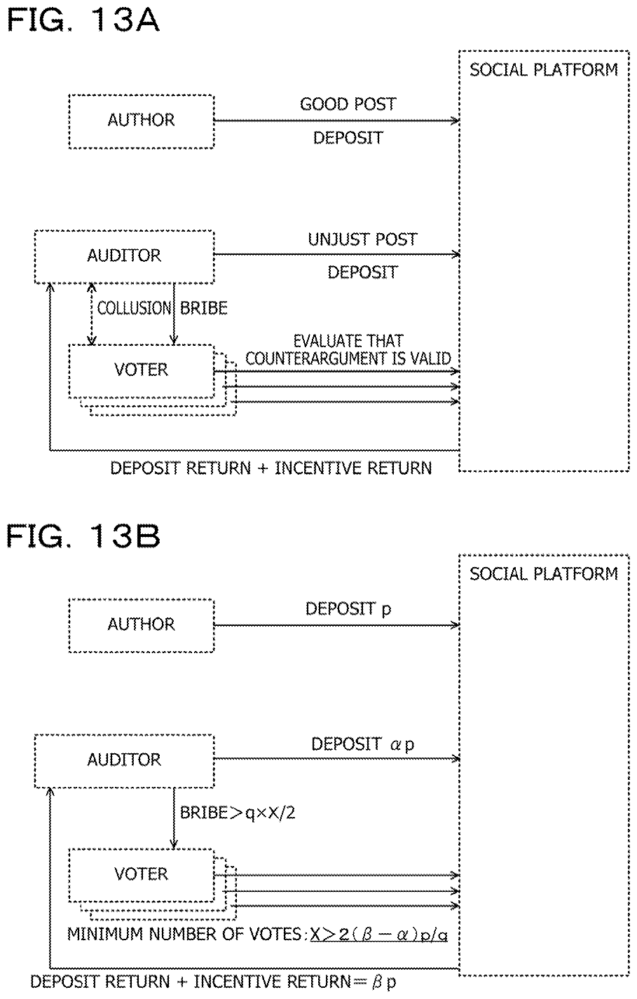

In the first embodiment, there is a possibility that the auditor and the voter commit a collusion fraud. FIG. 13A illustrates a procedure of the collusion fraud. The collusion fraud is committed as follows.

(1) Although the author has made a good post, the auditor who desires spread of incorrect information posts an unjust counterargument.

(2) The auditor offers bribes to a conspirator, and the conspirator votes (evaluate) that audit content is valid, as a voter.

(3) It is evaluated that the counterargument of the auditor is valid so that a deposit is returned to the auditor, and an incentive is returned to the auditor. This spreads the unjust counterargument as valid information.

In the first embodiment, even if such a collusion fraud is committed, the auditor is prevented from gaining a profit, for example, the auditor incurs a loss. Hereinafter, specific description will be made. As illustrated in FIG. 13B, a deposit amount of the author is assumed as p, a deposit amount of the auditor is assumed as αp, a total amount of deposit return and incentive return to the auditor is assumed as βp, and the total number of votes (minimum number of votes) that satisfies the evaluation condition (step S40 in FIG. 8) is assumed as X. Furthermore, it is assumed that an amount to buy one author by the auditor be q (≥1) (yen/person).

In this case, the total number of votes X that satisfies the evaluation condition is set as indicated in the following formula (1).

X>2(β−α)p/q (1)

As a result, even if the auditor buys a majority (>X/2 (people)) of the voters to establish fraud, a profit of the auditor βp−(αp+q×X/2) (yen) is less than zero yen. Therefore, it is possible to prevent collusion fraud. Note that the server 10 (voting reception unit 16) can set (determine) the total number of votes X. However, the embodiment is not limited to this, and a system administrator or the like may set the total number of votes X on the basis of the above formula (1).

The content described above will be described using a specific example.

For example, the deposit amount of the auditor is assumed as a half (α=0.5) of the deposit of the author, and the total amount of the deposit return and the incentive return to the auditor is assumed as a full deposit amount (β=1.0) of the author. Furthermore, it is assumed that an amount q to buy one author by the auditor be one (yen/person).

At this time, when it is assumed that the deposit amount p of the author be 100 yen, the total number of votes X that satisfies the evaluation condition is set to a number (101) that more than 100 people according to the following formula (2).

X>2(β−α)p/q=(2×(1.0−0.5)×100)/1=100 (2)

In this case, the auditor needs to buy at least a majority (51 (people)) of all voters to commit fraud. However, an income of the auditor is 100 yen, and a spend is a deposit 50 yen+a bribe 51 yen, and a profit is negative.

Note that, in the example described above, the minimum amount q of one yen is set as the amount used for buying. However, the embodiment is not limited to this, and the amount q may be appropriately changed according to the market price of the buying amount and calculated.

As described in detail above, according to the first embodiment, the deposit management unit 20 imposes a deposit when the author posts the posted content on the social platform and also imposes a deposit when the auditor posts the counterargument content against the posted content. Furthermore, in a case where the adoption determination unit 18 evaluates that the counterargument content is valid from the voting result of the voter, the adoption determination unit 18 returns the deposit and the incentive to the auditor. Then, in the first embodiment, the condition when the adoption determination unit 18 performs evaluation (the total number of votes X in the present embodiment) is determined not to cause a profit for the auditor even if the auditor offers bribes to the voter and commits fraud. As a result, in the present embodiment, it is possible to prevent the auditor who wishes the spread of an incorrect counterargument from performing an act for increasing the number of Accept votes by offering bribes to the voter and spreading the information as making the incorrect information appear as valid information. As a result, it is possible to prevent the spread of incorrect information. Furthermore, in the present embodiment, because the incentive is returned to the auditor who has performed valid audit, it is possible to promote self-purification of the incorrect information posted on the social platform. Furthermore, because the auditor and the author pay the deposits at the time of posting, it is possible to reduce posting of incorrect information and posting of an incorrect counterargument.

Furthermore, in the first embodiment, in a case where no counterargument against the posted content posted by the author is posted for a predetermined time or in a case where the counterargument is not evaluated as valid although the counterargument is posted, the deposit is returned and the incentive is returned to the author (step S74 in FIG. 12). As a result, it is possible to give a motivation to the author to correctly perform posting. Therefore, it is possible to prevent the author from posting incorrect information.

### SECOND EMBODIMENT

Next, a second embodiment will be described. In the second embodiment, a determination method of an adoption determination unit 18 is different from that in the first embodiment, and accordingly, a method for preventing collusion fraud is different from that in the first embodiment.

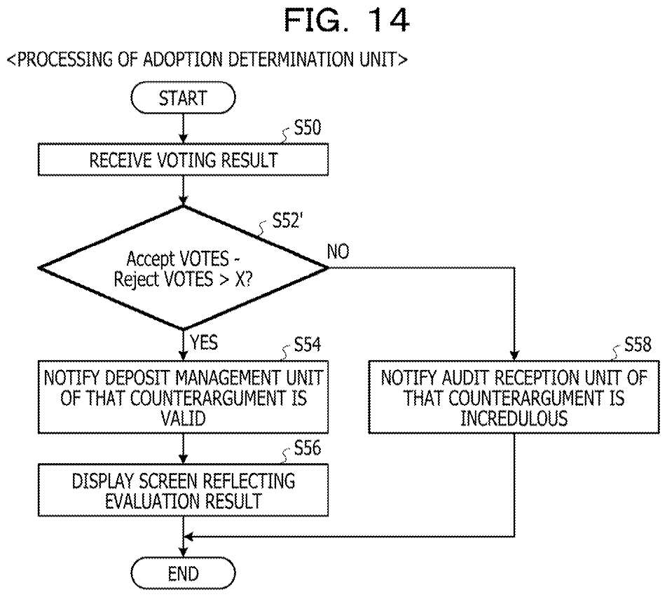

FIG. 14 is a flowchart illustrating processing of the adoption determination unit 18 according to the second embodiment. In the second embodiment, in a case where a difference between Accept votes and Reject votes is larger than X as in step S52′ in FIG. 14, the adoption determination unit 18 evaluates that a counterargument of an auditor is valid. Note that, in the second embodiment, it is assumed that a case where the voting reception unit 16 satisfies the evaluation condition (step S40 in FIG. 8, positive) be a case where predetermined voting reception period has elapsed.

### About Measures against Collusion Fraud

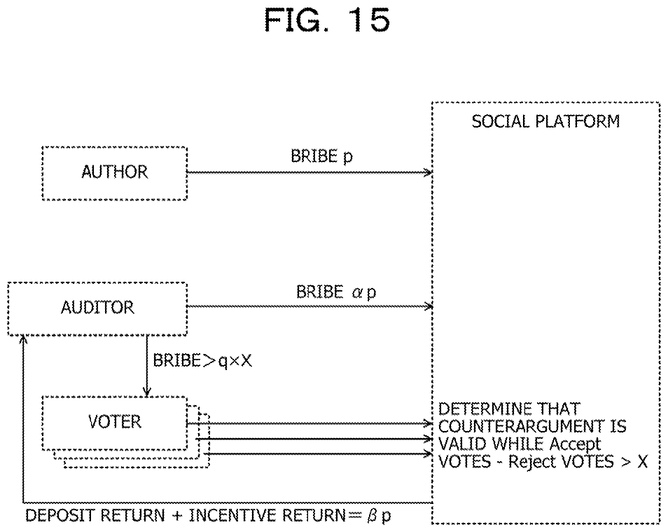

In the second embodiment, the auditor does not gain a profit even if the auditor commits the collusion fraud. Hereinafter, specific description will be made. As illustrated in FIG. 15, a deposit amount of an author is assumed as p, a deposit amount of the auditor is assumed as αp, and a total amount of deposit return and incentive return to the auditor is assumed as βp. Furthermore, it is assumed that an amount to buy one author by the auditor be q (□1) (yen/person).

In this case, a difference X between the number of Accept votes and the number of Reject votes used to determine that a counterargument is valid is set as the following formula (3).

X>(β−α)p/q (3)

Note that the server 10 (adoption determination unit 18) can set (determine) the difference X. However, the embodiment is not limited to this, and a system administrator or the like may set the total number of votes X on the basis of the above formula (3).

In this case, in order to establish the collusion fraud, the auditor needs to collude with X (people) at minimum. A profit of the auditor at this time is only βp−(αp+q×X) (yen), and this profit is less than zero yen under the condition of the above formula (3).

If it is assumed that Y (people) cast Reject votes, it is needed to buy (X+Y) (people) in order to establish collusion fraud. Therefore, the profit of the auditor is βp−(αp+q×(X+Y)) (yen). In this case, because the profit of the auditor is less than zero yen as described above even if Y is zero (people), it can be said that a deficit increases as Y increases.

The content described above will be described using a specific example.

For example, the deposit amount of the auditor is assumed as a half (α=0.5) of the deposit of the author, and the total amount of the deposit return and the incentive return to the auditor is assumed as a full deposit amount (β=1.0) of the author. Furthermore, it is assumed that an amount q to buy one author by the auditor be one (yen/person).

At this time, if it is assumed that the deposit amount p of the author be 100 yen, the difference X between the number of Accept votes and the number of Reject votes used to determine that the counterargument is valid is set to the number of people (51 people) more than 50 people according to the following formula (4).

X>(β−α)p/q=((1.0−0.5)×100)/1=50 (4)

In this case, the auditor needs to buy at least 51 (people) in order to commit collusion fraud. However, an income of the auditor is 100 yen, a spend is a deposit 50 yen+a bribe 51 yen, and the profit is negative.

Furthermore, in a case where there are 30 votes for Reject, it is needed to buy 81 (people) in order to commit collusion fraud. However, the income of the auditor in this case is 100 yen, and the spend is a deposit 50 yen+a bribe 81 yen, and the deficit further increases.

As described in detail above, according to the second embodiment, in a case where the number of Accept votes is larger than the number of Reject votes by a number equal to or more than a predetermined number X, the adoption determination unit 18 evaluates that the counterargument content is valid. Then, the predetermined number X is determined so as not to cause the profit even if the auditor commits collusion fraud. As a result, as in the first embodiment, it is possible to prevent the collusion fraud by the auditor and the voter.

### THIRD EMBODIMENT

Next, a third embodiment will be described. In the third embodiment, a determination method of an adoption determination unit 18 is different from that in the first and second embodiments, and accordingly, a method for preventing collusion fraud is different from that in the first and second embodiments.

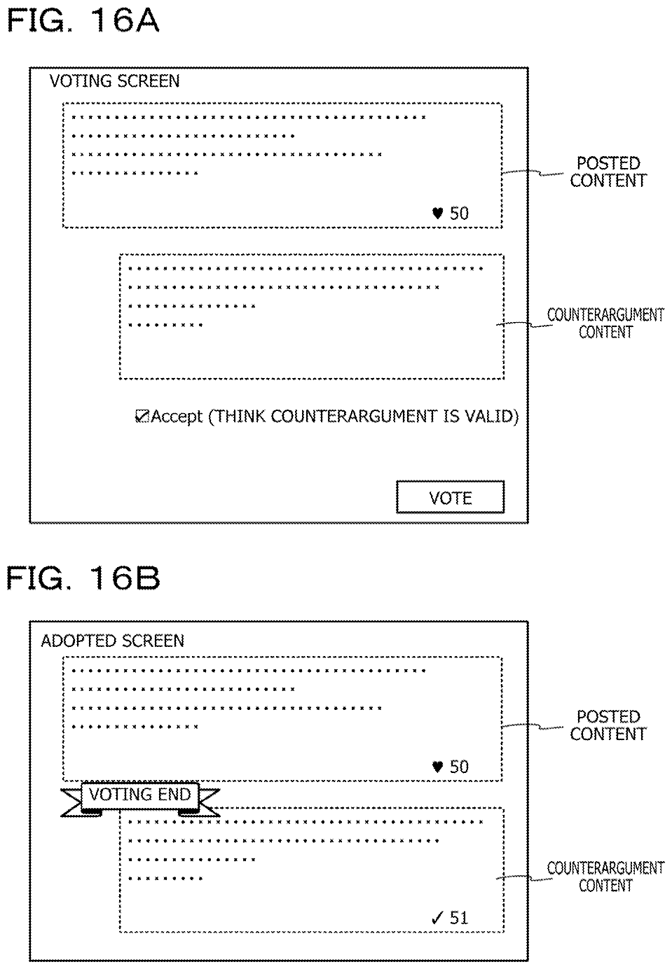

In the third embodiment, it is assumed that a voting screen as illustrated in FIG. 16A be used. If a voter thinks that a counterargument by an auditor is valid, the voter checks a checkbox of Accept and presses a “voting” button. On the other hand, in a case where the voter thinks that the counterargument by the auditor is incredulous, it is assumed that the voter does not cast a vote. Furthermore, in the third embodiment, it is possible to vote “Like” (heart mark in FIG. 16B) for posted content by an author.

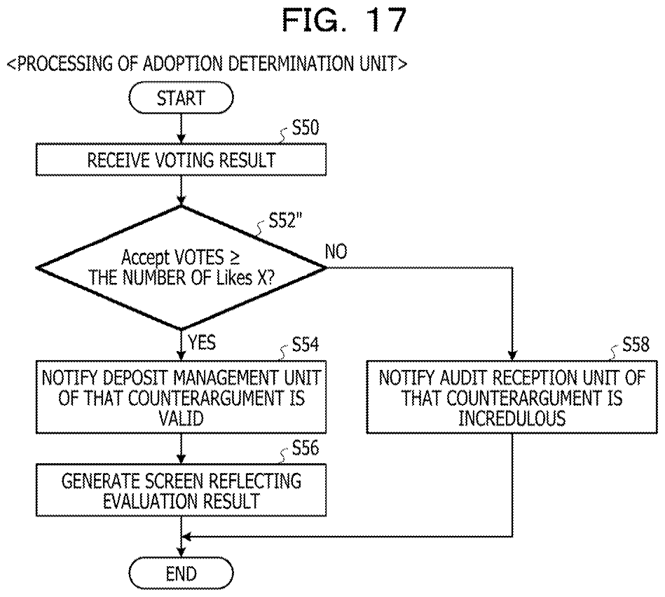

FIG. 17 is a flowchart illustrating processing of the adoption determination unit 18 according to the third embodiment. In the third embodiment, in a case where the number of Accept votes is equal to or more than the number of Likes (X) as in step S52″ in FIG. 17, the adoption determination unit 18 determines that the counterargument of the auditor is valid. Note that, in the third embodiment, it is assumed that a case where a voting reception unit 16 satisfies an evaluation condition (step S40 in FIG. 8, positive) be a case where a predetermined voting reception period has elapsed.

### About Measures against Collusion Fraud

In the third embodiment, the auditor does not gain a profit even if the auditor commits the collusion fraud. For example, a deposit amount of the author is assumed as p, a deposit amount of the auditor is assumed as αp, and a total amount of deposit return and incentive return to the auditor is assumed as βp. Furthermore, it is assumed that an amount to buy one author by the auditor be q (□1) (yen/person).

Then, a return rate β to the auditor is set as the following formula (5).

α<β<α+qX/p (5)

Note that a server 10 (voting reception unit 16) can set (determine) the return rate β. However, the embodiment is not limited to this, and a system administrator or the like may set the return rate β on the basis of the above formula (5).

In this case, in order to establish the collusion fraud, the auditor needs to collude with at least the number of Likes=X (people). However, the profit of the auditor at this time is βp−(αp+q×X) yen, and this profit is less than zero yen under the condition of the above formula (5).

The content described above will be described using a specific example.

For example, the deposit amount of the auditor is assumed as a half (α=0.5) of the deposit of the author.

At this time, if a deposit amount p of the author is 100 yen and the number of Likes X is 50 (people), the return rate β to the auditor can be set as the following formula (6) according to the above formula (5).

0.5<β<1.0 (6)

In this case, the auditor needs to buy at least 51 (people) in order to commit collusion fraud. However, an income of the auditor is 100 yen, a spend is a deposit 50 yen+a bribe 51 yen, and the profit is negative.

Note that, in the third embodiment, in a case where the number of Accept votes is equal to or more than the number of Likes (X) when the voting reception period has elapsed, an adopted screen as illustrated in FIG. 16B is displayed.

As described in detail above, according to the third embodiment, the adoption determination unit 18 evaluates that the counterargument content is valid in a case where the number of Accept votes against the counterargument is larger than the number of Likes for the posted content. Then, the return rate β to the auditor is determined so that no profit is caused even if the auditor commits collusion fraud. As a result, as in the first and second embodiments, it is possible to prevent the collusion fraud by the auditor and the voter.

Note that, in the first to the third embodiments described above, it is premised that a general voter who is not complicit in collusion fraud casts a Reject vote for an unjust counterargument (or does not cast Accept vote). However, in reality, there is a possibility that even a general voter casts the Accept vote for the unjust counterargument. For example, this is a case where an Accept vote is casted as mischief against an unjust counterargument, a case where an Accept vote is casted while believing that the unjust counterargument is a valid counterargument or wrongly assuming the unjust counterargument as valid, or the like.

Therefore, in a case where the information processing system according to the first to the third embodiments described above is actually operated, it is preferable to consider bias and noise included in such a general voter. In this case, it is preferable to adjust the number of votes to be the evaluation condition (step S40 in FIG. 8) or the return rate to the auditor in consideration of the bias included in the voter.

For example, in a case where attributes of voters are biased or in a case where the auditor and the voter have a close or hostile relationship even if the auditor and the voter do not collude, there is a possibility that organized votes, partial votes, or prejudice is included in evaluation. In such a case, it is preferable to perform the following adjustments.

### Adjust on the Basis of Follow Relationship between Voters

For example, in a case where a cluster coefficient (one of indicators indicating sparseness of relationship between nodes in network) of a set of voters is large, it can be said that the relationship between the voters is close. In such a case, it is preferable to set the needed number of votes that is larger than that in the first embodiment.

### Adjust on the Basis of Relationship between Auditor and Voter

It is preferable to weight votes from a voter who has casted a vote for counterarguments of the same auditor in the past with reference to a posting history of the author and to reduce an influence of the vote. For example, one vote from such a voter can be assumed as 0.5 vote.

Note that the processing functions described above may be implemented by a computer. In that case, a program is provided in which processing content of a function that a processing device should have is described. The program is executed on the computer, whereby the processing functions described above are implemented on the computer. The program in which the processing content is described may be recorded in a computer-readable storage medium (note that a carrier wave is excluded).

In a case of distributing the program, for example, the program is sold in a form of a portable storage medium such as a digital versatile disc (DVD) or a compact disc read only memory (CD-ROM) in which the program is recorded. Furthermore, it is also possible to store the program in a storage device of a server computer and transfer the program from the server computer to another computer via a network.

The computer that executes the program stores, for example, the program recorded in the portable storage medium or the program transferred from the server computer in a storage device of the computer. Then, the computer reads the program from the storage device of the computer and executes processing according to the program. Note that the computer may also read the program directly from the portable storage medium and execute processing according to the program. Furthermore, the computer may also sequentially execute processing according to the received program each time the program is transferred from the server computer.

The embodiments described above are preferred examples of the present disclosure. However, the embodiment is not limited to this, and various modifications may be made without departing from the scope of the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a posted content audit program for causing a computer to execute processing comprising:
imposing a first deposit when a first user posts posted content on a social platform;
imposing a second deposit when a second user posts counterargument content against the posted content;
receiving voting regarding whether or not the counterargument content is valid and evaluating whether or not the counterargument content is valid;
returning the second deposit and returning an incentive to the second user in a case where it is evaluated that the counterargument content is valid as a result of the voting; and
determining a condition when it is evaluated whether or not the counterargument content is valid or return content of the incentive so that the second user does not gain a profit even when the second user offers bribes to a user who casts the vote and commits fraud.

2. The non-transitory computer-readable recording medium according to claim 1, wherein
in the evaluating processing, in a case where it is evaluated that the counterargument content is valid in a case where the number of votes that indicates that the counterargument content is valid is more than the number of votes that indicates that the counterargument content is not valid,
a minimum number of votes needed when evaluation is made is determined so that the second user does not gain a profit even when the second user commits the fraud.

3. The non-transitory computer-readable recording medium according to claim 1, wherein
in the evaluating processing, in a case where it is determined that the counterargument content is valid in a case where a difference between the number of votes that indicates that the counterargument content is valid and the number of votes that indicates that the counterargument content is not valid is more than a predetermined number,
the predetermined number is determined so that the second user does not gain a profit even when the second user commits the fraud.

4. The non-transitory computer-readable recording medium according to claim 1, for causing the computer to execute processing further comprising:
receiving a vote regarding whether or not the posted content is valid, wherein
in the evaluating processing, in a case where it is determined that the counterargument content is valid when the number of votes that indicates that the counterargument content is valid is more than the number of votes that indicates that the posted content is valid,
the return content is determined so that the second user does not gain a profit even when the second user commits the fraud.

5. The non-transitory computer-readable recording medium according to claim 1, for causing the computer to execute processing further comprising:
returning the first deposit and returning an incentive to the first user in a case where it is evaluated that the counterargument content is not valid as a result of the evaluation or in a case where the counterargument content is not posted for a predetermined time.

6. The non-transitory computer-readable recording medium according to claim 1, wherein in the determining processing, the condition when it is evaluated whether or not the counterargument content is valid or the return content of the incentive is determined on the basis of at least one of an attribute or a posting history of a user who casts the vote.

7. The non-transitory computer-readable recording medium according to claim 2, wherein
in a case where an amount of the first deposit is assumed as p, an amount of the second deposit is assumed as αp, a total amount of the second deposit and the incentive is assumed as βp, the minimum number of votes is assumed as X, and an amount of a bribe given to one user who casts the vote so that the second user commits the fraud is assumed as q,
the minimum number of votes X is
determined so as to satisfy X>2(β−α) p/q.

8. The non-transitory computer-readable recording medium according to claim 3, wherein
in a case where an amount of the first deposit is assumed as p, an amount of the second deposit is assumed as αp, a total amount of the second deposit and the incentive is assumed as βp, the predetermined number is assumed as X, and an amount of a bribe given to one user who casts the vote so that the second user commits the fraud is assumed as q,
the predetermined number X is
determined so as to satisfy X>(β−α) p/q.

9. The non-transitory computer-readable recording medium according to claim 4, wherein
in a case where an amount of the first deposit is assumed as p, an amount of the second deposit is assumed as αp, a total amount of the second deposit and the incentive is assumed as βp, the number of votes that indicates that the posted content is valid is assumed as X, and an amount of a bribe given to one user who casts the vote so that the second user commits the fraud is assumed as q,
a value of β is determined so as to satisfy α<β<α+qX/p.

10. A posted content audit method comprising:
imposing, by a computer, a first deposit when a first user posts posted content on a social platform;
imposing a second deposit when a second user posts counterargument content against the posted content;
receiving voting regarding whether or not the counterargument content is valid and evaluating whether or not the counterargument content is valid;
returning the second deposit and returning an incentive to the second user in a case where it is evaluated that the counterargument content is valid as a result of the voting; and
determining a condition when it is evaluated whether or not the counterargument content is valid or return content of the incentive so that the second user does not gain a profit even when the second user offers bribes to a user who casts the vote and commits fraud.
